(19) United States
(12) Patent Application Publication
(10) Pub. No.: US 2007/0211464 A1
(43) Pub. Date: Sep. 13, 2007

(54) Shapeable decoration lamp series

(76) Inventor: Chih-Chung Tao, Taipei (TW)

Correspondence Address: CHIH-CHUNG TAO, 235 Chung - Ho, Box 8-24, Taipei, TW

(21) Appl. No.: 11/367,999

(22) Filed: Mar. 6, 2006

(51) Int. Cl. F21S 13/14

(52) U.S. Cl. 362/252

(57) ABSTRACT

A shapeable decoration lamp series comprises at least one light emitting wire bank; each light emitting wire bank having at least one end having a terminal; a connector being connected to the terminal of the light emitting wire bank; and at least one non-light emitting wire bank; each non-light emitting wire bank having at least one end having a terminal. Each light emitting wire bank includes a plurality of light emitting elements and the terminal. The transmission line is a flexible transmission line so as to be bent to a predetermined characters or patterns as a decorations. The non-light emitting wire bank is made of flexible transmission line. The terminal is connected to a control box; the control box is a battery with a control circuit, or a cigar-lighter with a control circuit therein; the control box serves to control the illuminations of the light emitting elements.

### FIELD OF THE INVENTION

The present invention relates to decorating lamps, and in particular to a shapeable decoration lamp series, wherein the shapeable decoration lamp series can be shaped to a desired shape, moreover, with the installation of the non-light emitting wire bank, the present invention can be used to present characters. Thereby the illuminations of the lamps in the device are controllable so as to have preferred illumination effect. The user can form a desire pattern immediately with mold is used.

### BACKGROUND OF THE INVENTION

In the prior art Christmas lamp series, each lamp has a seat and a bulb assembled thereon. The seats are connected by soft transmission line. One end of the transmission line has a plug for power transmission.

The prior art Christmas lamp series can be wound around a tree, a door, or a window so as to have the effect of decoration. However the prior art Christmas lamp series is not suitable to be formed characters or patterns. In the prior art, if it is desired to form characters or patterns by Christmas lamp series. A mold is used. However this will confine the use of the Christmas lamp series. The user cannot design a desired pattern or a character set as desired and immediately.

### SUMMARY OF THE INVENTION

Accordingly, the primary object of the present invention is to provide a shapeable decoration lamp series, wherein the shapeable decoration lamp series can be shaped to a desired shape, moreover, with the installation of the non-light emitting wire bank, the present invention can be used to present characters. Thereby the illuminations of the lamps in the device are controllable so as to have preferred illumination effect. The user can form a desire pattern immediately with mold is used.

To achieve above objects, the present invention provides a shapeable decoration lamp series; which comprises at least one light emitting wire bank; each light emitting wire bank having at least one end having a terminal; a connector being connected to the terminal of the light emitting wire bank; and at least one non-light emitting wire bank; each non-light emitting wire bank having at least one end having a terminal. Each light emitting wire bank includes a plurality of light emitting elements, and the terminal. The transmission line is a flexible transmission line so as to be bent to a predetermined characters or patterns as a decorations. The non-light emitting wire bank is made of flexible transmission line. The terminal is connected to a control box; the control box is a battery with a control circuit, or a cigar-lighter with a control circuit therein; the control box serves to control the illuminations of the light emitting elements.

The various objects and advantages of the present invention will be more readily understood from the following detailed description when read in conjunction with the appended drawing.

### BRIEF DESCRIPTION OF THE DRAWINGS

FIG. 1 is a schematic perspective view about the shapeable lamp decoration of the present invention is illustrated.

FIG. 2 shows the first embodiment of the present invention.

FIG. 3 shows the second embodiment of the present invention.

FIG. 4 is a schematic view about the third embodiment of the present invention.

FIG. 5 shows the schematic view about the fourth embodiment of the present invention.

FIG. 6 shows the fifth embodiment of the present invention.

FIG. 7 is a schematic view about the assembly of the present invention.

FIG. 7A is a cross sectional view of the female terminal of the present invention.

FIG. 7B is a cross sectional view about the male terminal of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

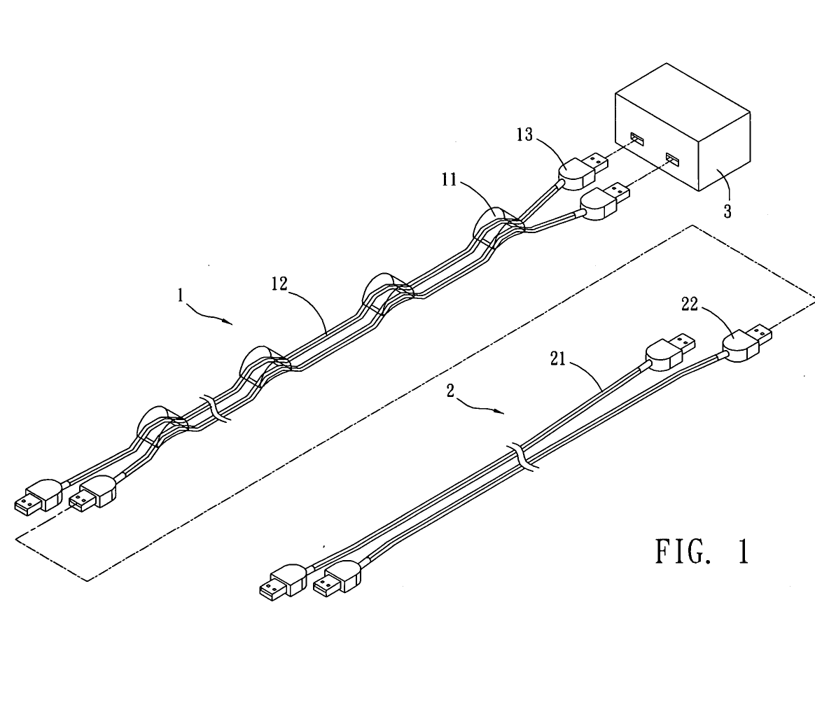

Referring to FIGS. 1 to 7, the present invention is illustrated. The present invention provides the user can design a series of lamp decorations with a desired number and length. The present invention has the following elements.

A light emitting wire bank 1 includes a plurality of light emitting elements 11, a transmission line 12 serially connecting the light emitting elements 11 and a terminal set 13. The transmission line 12 may be a slender transmission line 12 which has a small volume and is power-save. The light emitting elements 11 may be multi-color or single color light emitting diodes with high illumination. The transmission line 12 is flexible so that the user can bend the transmission line 12. The terminal set 13 may have one or two terminals which may include male terminal or female terminal so as to prevent the error from the fault of connections of the polarities which will induce that the light emitting wire bank 1 is destroyed. The terminal set 13 can be connected to a control box 3. The control box 3 may be a general used control box or a movable control box with a control circuit therein, or a general used cigar-lighter with a control circuit therein. The control box 3 can be serially connected to the light emitting elements 11 of the light emitting wire bank 1.

At least one non-light emitting wire bank 2 is made of flexible transmission lines 21. One of the transmission lines 21 has terminals 22 which include male terminals or female terminals so as to prevent the error from the fault of connections of the polarities so that the light emitting wire bank 1 destroys.

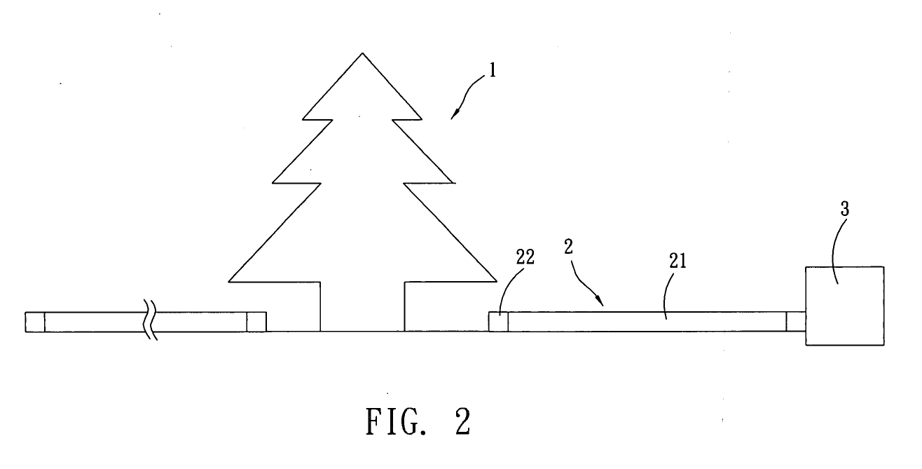

Referring to FIG. 2, another embodiment of the present invention is illustrated. As shown in the drawing, in use of the present invention, the user can bend the light emitting wire bank 1 to a pattern or characters (as an indoor decoration or a signboard or a neon light). Meanwhile, One terminal of the terminal set 13 can be connected to a control box 3 and another terminal of the terminal set 13 is connected to the terminal 22 of the non-light emitting wire bank 2 to form a gap in a pattern or a character.

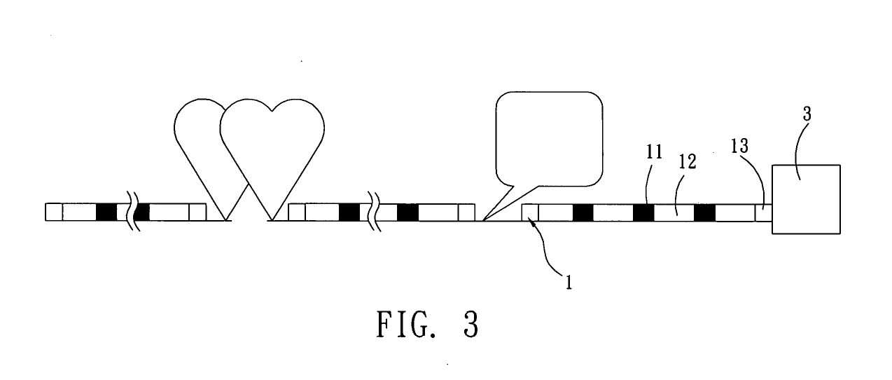

Referring to FIG. 3, the second embodiment of the present invention is illustrated. As illustrated in the drawing, the light emitting wire bank 1 of a single color or having a fixed length is connected to a control box 3 through the terminal set 13. The light emitting wire bank 1 bent as character or pattern can be connected to a plurality of control box 3 so as to have decoration lamps of various forms.

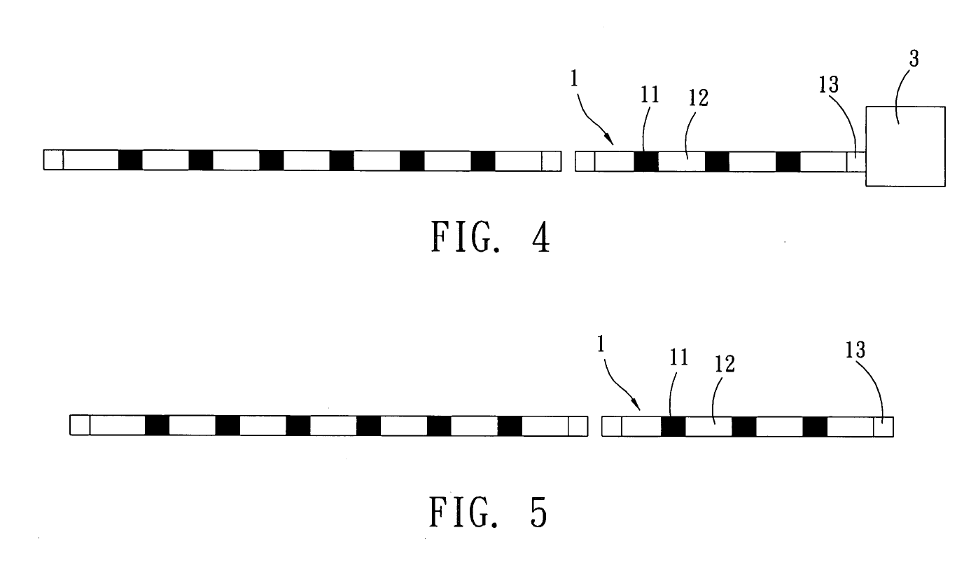

Referring to FIG. 4, the third embodiment of the present invention is illustrated. The multi-color light emitting wire banks 1 of different lengths are connected to the control box 3 through the terminal set 13 so as to have a multi-color decorations.

Referring to FIG. 5, the fourth embodiment of the present invention is illustrated. The multi-color light emitting wire banks 1 of different lengths are serially connected. Each light emitting element 11 has a control chip therein. Then the multi-color light emitting wire banks 1 are connected as a character and are powered. The control chips control the illuminations of the light emitting elements 11 randomly. No control box is used.

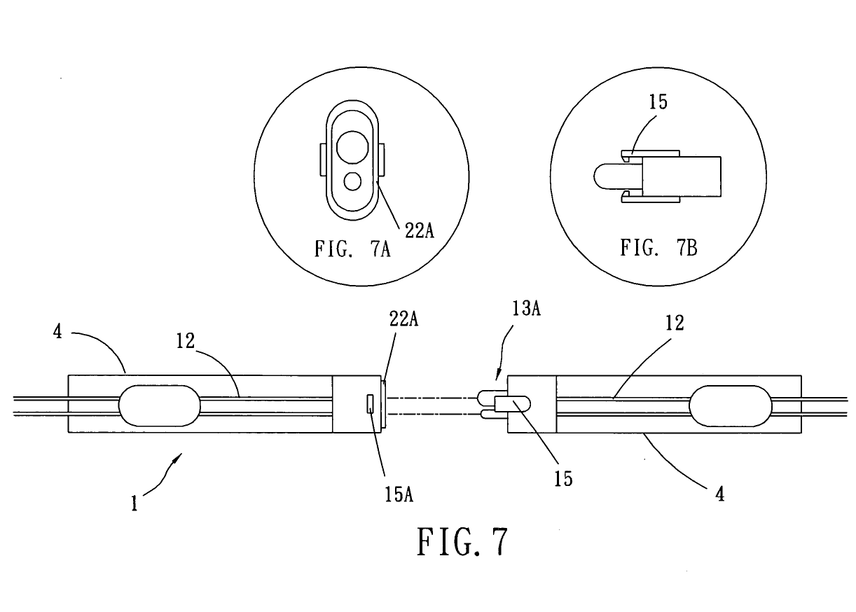

Referring to FIGS. 7, 7A, and 7B, another form of the present invention is illustrated. It is illustrated that the two sides of the male terminal 13A have two buckles 15. Two lateral sides of the female terminal 22A are two recesses 15A for receiving the buckles 15 of the male terminal 13A so that the terminals can be connected correctly. The terminals can be connected to non-light emitting wire banks 2 or control boxes.

Furthermore, in the present invention, the terminals of the light emitting wire bank 1 and non-light emitting wire bank 2 can be USB connector to be connected to computers. Thereby power is received from the computer. The illumination of the lamps can be controlled by the computer.

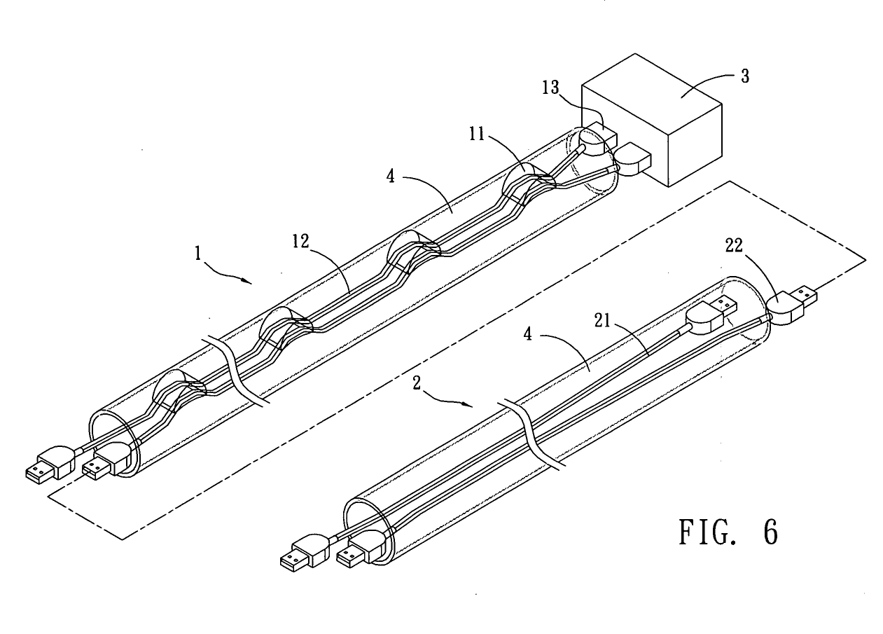

Moreover in the present invention, as shown in FIGS. 6 and 7, the outer sides of the light emitting wire bank 1 and the non-light emitting wire bank 2 are enclosed by outer tubes 4 so as to have the function of waterproof. Furthermore, the outer tubes 4 have the function of light guiding so that the decorations formed by the light emitting wire banks 1 and non-light emitting wire banks 2 are used as neon lights.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A shapeable decoration lamp series; comprising:
at least one light emitting wire bank; each light emitting wire bank having at least one end having a terminal;
a connector being connected to the terminal of the light emitting wire bank; and
at least one non-light emitting wire bank; each non-light emitting wire bank having at least one end having a terminal.

2. The shapeable decoration lamp series as claimed in claim 1, wherein each light emitting wire bank includes a plurality of light emitting elements and the terminal.

3. The shapeable decoration lamp series as claimed in claim 1, wherein the transmission line is power-saved micro-transmission line with very small size and the light emitting element is at least one of a single color light emitting diode and a multi-color light emitting diode.

4. The shapeable decoration lamp series as claimed in claim 1, wherein the transmission line is a flexible transmission line so as to be bent to a predetermined characters or patterns as a decorations.

5. The shapeable decoration lamp series as claimed in claim 1, wherein the terminals include at least one of male terminals and female terminals; one of the male terminal and female terminal has buckles and the other one has recesses for buckling the buckles so that the connection of the terminal will be correct.

6. The shapeable decoration lamp series as claimed in claim 2, wherein the terminal is connected to a control box; the control box is a battery with a control circuit, or a cigar-lighter with a control circuit therein; the control box serves to control the illuminations of the light emitting elements.

7. The shapeable decoration lamp series as claimed in claim 1, wherein the non-light emitting wire bank is made of flexible transmission line.

8. The shapeable decoration lamp series as claimed in claim 2, wherein each light emitting element has a control chip therein. Then the multi-color light emitting wire banks are connected as a character and are powered; the control chips control the illuminations of the light emitting elements randomly.

9. The shapeable decoration lamp series as claimed in claim 1, wherein the terminals of the light emitting wire bank and non-light emitting wire bank are USB connector to be connected to computers; power is received from the computer; and thus the illumination of the lamps can be controlled by the computer.

10. The shapeable decoration lamp series as claimed in claim 1, wherein outer sides of the light emitting wire bank and the non-light emitting wire bank are enclosed by outer tubes so as to have the function of waterproof; the outer tubes have the function of light guiding so that the decorations formed by the light emitting wire banks and non-light emitting wire banks are used as neon lights.
